(19) United States
(12) Patent Application Publication
(10) Pub. No.: US 2019/0356661 A1
(43) Pub. Date: Nov. 21, 2019

(54) PROXY MANAGER USING REPLICA AUTHENTICATION INFORMATION

(71) Applicant: CyberArk Software Ltd., Petach-Tikva (IL)

(72) Inventor: Asaf HECHT, Tel Aviv (IL)

(73) Assignee: CyberArk Software Ltd., Petach-Tikva (IL)

(21) Appl. No.: 15/985,605

(22) Filed: May 21, 2018

(51) Int. Cl. H04L 29/06; H04L 9/08; H04L 9/14

(52) U.S. Cl. CPC H04L 63/0884; H04L 63/108; H04L 9/14; H04L 9/0891; H04L 9/0838

(57) ABSTRACT

Systems and methods are provided for enabling source resources to communicate with access-restricted target resources. The method can include receiving, at a proxy manager, a request from a source resource to access an access-restricted target resource. The request can include replica authentication information inoperable to enable the source resource to access the access-restricted target resource. The method can further include generating, in response to the request, temporary authentication information corresponding to the replica authentication information. The temporary authentication information can be operable to enable the source resource to access the access-restricted target resource. The method can additionally include making available to the access-restricted target resource the temporary authentication information, without sending the temporary authentication information to the source resource. The method can further include revoking the temporary authentication information after it was made available to the access-restricted target resource.

### BACKGROUND

Virtualization technologies are broadly applicable in many technological fields. As a result, many organizations worldwide rely on virtualization to reduce development times and development costs, increasing the flexibility and scalability of applications. Organizations can rely on on-premises or cloud-computing platforms, such as AMAZON WEB SERVICES, MICROSOFT AZURE, and others.

These platforms can be configured to host services. Applications hosted on the platforms or other computing systems can communicate with these services, providing requests and receiving responses. Such an application can contact a target service using a call to an application programming interface (API). The platform can be configured to authenticate the API request using authentication information included with the API request. This information can be an access credential or can be generated using an access credential. The platform can be configured to check the authentication information and only permit execution of the API request when the authentication information is valid.

Access credentials are very sensitive because they can enable automatic execution of API requests. Attackers attempting to perform malicious actions using corresponding target services will search compromised networks for access credentials. Unfortunately, according to conventional practice, access credentials are stored in or with the source application that contacts the target service. For example, the access keys can be hardcoded into the application or stored in a location accessible to the application. The access keys may also be stored on a physical or virtual machine finning the application. An attacker that successfully compromised this machine could steal the access credentials and impersonate the application.

Therefore, a need exists for systems and methods that prevent attackers from using access credentials stored on a compromised machine or network. Such a technique should also protect against accidental or deliberate disclosure of access credentials. Furthermore, such a technique should reduce the risk that employees could make unauthorized use of access keys.

### SUMMARY

The disclosed embodiments describe systems and methods for enabling source resources to communicate with access-restricted target resources. Such systems and methods can use a proxy manager and replica authentication information inoperable to access the access-restricted target resources. According to the disclosed systems and methods, the source resources can provide requests including the replica authentication information. The requests can be provided to a cloud environment and/or an on-premises system. The proxy manager can intercept these requests. The proxy manager can modify the intercepted requests to include temporary authentication information operable to access the access-restricted target resources. Credentials for inclusion in, or for generating, the temporary authentication information are accessible to the proxy manager.

The disclosed embodiments can include a non-transitory computer readable medium. The medium can contain instructions that, when executed by at least one processor, cause the at least one processor to perform operations for enabling source resources to communicate with access-restricted target resources. The operations can include receiving, at a proxy manager, a request from a source resource to access an access-restricted target resource. The request can include authentication information that is inoperable to enable the source resource to access the access-restricted target resource. The operations can further include generating, in response to the request, temporary authentication information. The temporary authentication information can correspond to the replica authentication information. The temporary authentication information can be operable to enable the source resource to access the access-restricted target resource. The operations can further include making available to the access-restricted target resource the temporary authentication information, without sending the temporary authentication information to the source resource. The operations can additionally include revoking the temporary authentication information after it was made available to the access-restricted target resource.

In some embodiments, making available to the access-restricted target resource the temporary authentication information can include modifying the request to include the temporary authentication information. In some aspects, modifying the request can include signing at least a portion of the request using a cryptographic cloud key to generate the temporary authentication information. In various embodiments, making available to the access-restricted target resource the temporary authentication information can include generating, at the proxy manager, a new message including the temporary authentication information and sending the new message to the access-restricted target resource. In certain embodiments, making available to the access-restricted target resource the temporary authentication information can include combining the temporary authentication information with additional authentication information.

In some embodiments, the revoking can occur upon the termination of a session between the source resource and the access-restricted target resource. In various aspects, the revoking can occur according to a revocation schedule. In some aspects, the operations can further comprise identifying a portion of the request comprising the replica authentication information and modifying the request by replacing the portion of the request with a substitute portion comprising the temporary authentication information.

In various embodiments, the replica authentication information can be generated using a corresponding cryptographic source key and the temporary authentication information can be generated using a corresponding cryptographic cloud key. The request can be an API request from an application running on the source resource. In some embodiments, a cryptographic source key for inclusion in, or for use in generating, the replica authentication information is integrated into the application. In some embodiments, a cryptographic source key for generating the replica authentication information can be stored in local memory on the source resource. In various embodiments, the proxy manager is configured to intercept the request before it reaches the access-restricted target resource.

In some embodiments, a credential management resource can be configured to store pairs of corresponding cryptographic source keys for including in, or for generating, replica authentication information and cryptographic cloud keys for including in, or for generating, temporary authentication information. In some aspects, the proxy manager can be configured to replace the cloud credentials with replacement cloud credentials. In various aspects, the replica authentication information can include metadata identifying the source resource.

The disclosed embodiments can include a computer-implemented method for enabling source resources to communicate with access-restricted target resources. The method can include receiving, at a proxy manager, a request from a source resource to access an access-restricted target resource. The request can include replica authentication information. The replica information can be inoperable to enable the source resource to access the access-restricted target resource. The method can further include generating, in response to the request, temporary authentication information corresponding to the replica authentication information. The temporary authentication information can be operable to enable the source resource to access the access-restricted target resource. The method can further include making available to the access-restricted target resource the temporary authentication information, without sending the temporary authentication information to the source resource. The method can additionally include revoking the temporary authentication information after it was made available to th access-restricted target resource.

In some embodiments, the proxy manager can apply an authorization policy to the request prior to making the temporary authentication information available to the access-restricted target resource. In various embodiments, the proxy manager can be configured to detect anomalous usage of a source cryptographic key. In various embodiments, the proxy manager can be configured to identify the source resource as compromised.

In some embodiments, the proxy manager can be configured to detect use of replica authentication information including, or generated with, a decoy credential, the decoy credential created to identify potential malicious activity and lacking a corresponding credential for generating temporary authentication information.

In some embodiments, the authorization policy can impose a time limit on source cryptographic key validity. In various embodiments, the authorization policy can impose a single-usage limit on source cryptographic key validity. In some embodiments, the proxy manager can be configured to deny access to the access-restricted target resource when the request does not comply with the authentication policy. In some embodiments, the proxy manager can be configured to flag the source resource for investigation when the request does not comply with the authentication policy.

In some embodiments, the proxy manager can be configured to determine whether the replica authentication information is associated with the source resource. In various embodiments, the proxy manager can be configured to dynamically create a cloud credential for inclusion in, or for generating, the temporary authentication information in response to the request.

It is to be understood that both the foregoing general description and the follow detailed description are exemplary and explanatory only and are not restrictive of the disclosed embodiments, as claimed.

### BRIEF DESCRIPTION OF THE DRAWINGS

The accompanying drawings are not necessarily to scale or exhaustive. Instead, emphasis is generally placed upon illustrating the principles of the inventions described herein. These drawings, which are incorporated in and constitute a part of this specification, illustrate several embodiments consistent with the disclosure and, together with the detailed description, serve to explain the principles of the disclosure. In the drawings:

FIG. 1A depicts a schematic illustrating an exemplary system for enabling source resources to communicate with access-restricted target resources.

FIG. 1B depicts an exemplary secure storage system including a transformation table.

FIG. 1C depicts an exemplary manager system including API rules, Key Rules, and Source Profiles.

FIG. 2 depicts an exemplary method for accessing a cloud environment using replica authentication information.

FIG. 3 depicts an exemplary method for detecting compromised systems.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence, nor constrained to a particular system configuration. Additionally, some of the described embodiments or elements thereof can occur or be performed simultaneously, at the same point in time, or concurrently. Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

Authentication information can include various types of data used for authenticating identities, such as digital signatures, tokens, keys, keyed hashes, passwords, biometric information, and the like. Authentication information can include temporary authentication information and replica authentication information. Authentication information can include credentials, such as cryptographic keys, in some embodiments. These keys can be symmetric keys. Authentication information can be generated using credentials, such as cryptographic keys, in some embodiments (e.g., HMAC authentication). The cryptographic keys can be symmetric keys. Source credentials can be (or be used to generate) replica authentication information. Cloud credentials can be (or be used to generate) temporary authentication information. Other types of keys and authentication information are possible as well.

According to the envisioned systems and methods, a source credential can be used to access a computing resource, such as a computing resource provided by a cloud-based and/or on-premises system. The source credential can be “valid,” or usable to access the computing resource, for a certain duration, number of uses, or until a criterion is satisfied. For example, a source credential can be valid for a minute, hour, day, week, month, or the like. As an additional example, source credentials can be valid for a single use, or a predetermined multiple number of uses. As a further example, source credentials can be valid until revoked as comprised by an intruder. Multiple validity conditions can apply to source credentials. For example, a source credential can be valid for a week, until it has been used 10 times, or until revoked. Cloud credentials can similarly be used to access a computing resource and can be “valid” subject o conditions as described above. For example, cloud credentials can be valid for a week, until used 10 times, or until revoked.

Replica authentication information can be used to access a proxy manager, but cannot be used to access the cloud-based and/or on-premises system. In some embodiments, replica authentication information may resemble temporary authentication information. For example, the temporary authentication information and the replica authentication information can share a datatype, template, or structure. But unlike the temporary authentication information, the replica authentication information may have values that are not recognized by the cloud-based and/or on-premises system. Alternatively, the replica authentication information may be recognized, but rejected, by the cloud-based and/or on-premises system. In various embodiments, replica authentication information may not resemble temporary authentication information. For example, the temporary authentication information and the replica authentication information may differ in at least one of datatype, template, content, and structure.

A source resource can provide a request and replica authentication information to the proxy manager. The proxy manager can be configured to replace the replica authentication information with temporary authentication information. The proxy manager can then provide the request and temporary authentication information to the cloud based and/or on-premises system. In some embodiments, the temporary authentication information can be a credential shared with the cloud-based and/or on-premises system. In various embodiments, the temporary authentication information can be generated using a credential shared with the cloud-based and/or on-premises system. In some embodiments, the cloud-based and/or on-premises system can be configured to revoke this credential after receiving temporary authentication information generated with the credential a certain number of times. For example, the cloud-based and/or on-premises system can be configured to accept the temporary authentication information once, and subsequently reject the temporary authentication information,

The disclosed systems and methods address vulnerabilities of existing systems. For example, though an attacker or disaffected employee might access stored credentials, such stored credentials would not provide direct access to services hosted on the cloud-based and/or on-premises system. Likewise, the disclosed systems and methods protect against accidental publication of stored credentials (e.g., to a GitHub or other public repository), as the published credentials would not provide direct access to the cloud-based and/or on-premises system. Furthermore, by requiring indirect access through a proxy manager, the envisioned systems and methods support centralization of access authentication. This centralization in turn supports credential management (e.g., key rotation, auditing, usage logging, and the like). Furthermore implementing the disclosed systems and methods requires minimal changes to existing infrastructure. For example, existing applications can be re-provisioned with new credentials and access requests can be redirected to the proxy manager.

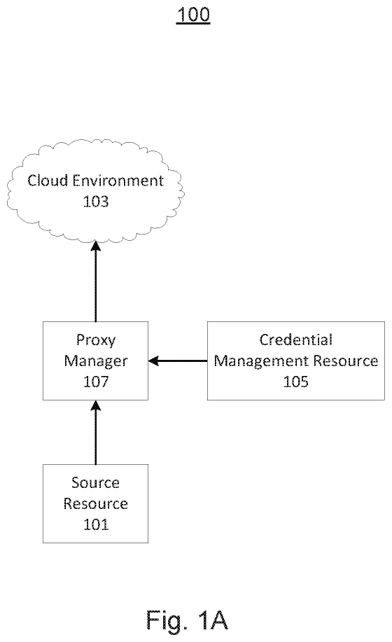

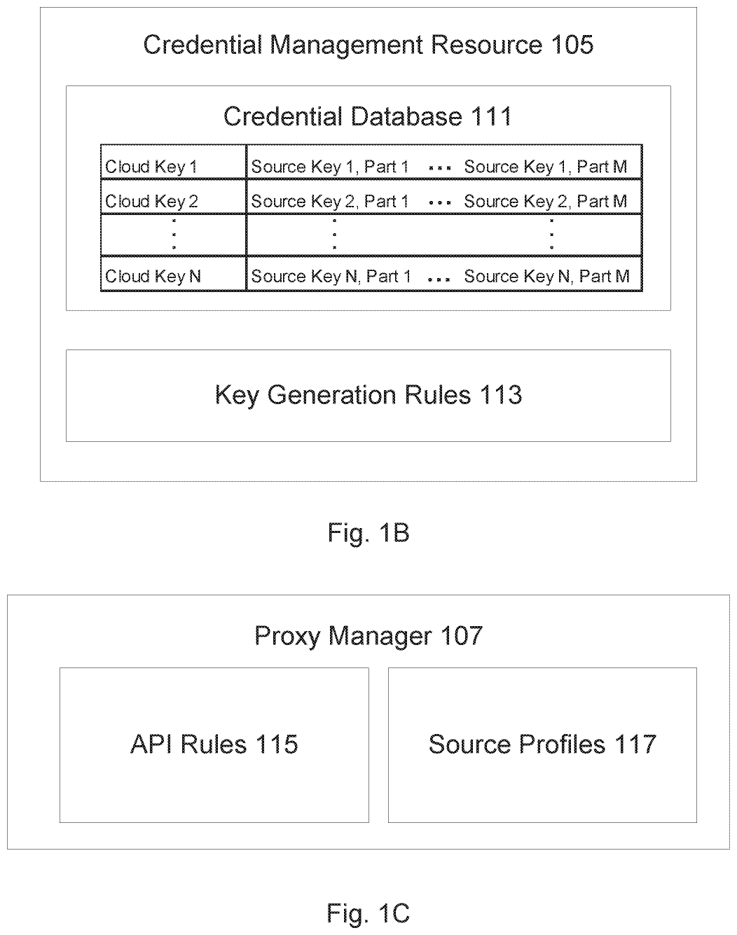

FIG. 1A depicts a schematic illustrating an exemplary system 100 for enabling source resources 101 to communicate with access-restricted target resources (e.g., in cloud environment 103), consistent with disclosed embodiments. In some embodiments, source resource 101 can be configured to request access to an access-restricted target resource running on cloud environment 103. This request can include replica authentication information. Proxy manager 107 can be configured to retrieve credentials from credential management resource 105. Using the retrieved credentials, proxy manager 107 can recreate the source request. The recreated source request can include temporary authentication information. Proxy manager 107 can then provide the recreated request to the access-restricted target resource running in cloud environment 103. Cloud environment 103 can authenticate the request using the temporary authentication information. The access-restricted target resource can then perform the requested action (and can return any requested result). In this manner, exemplary system 100 can enable source resources to communicate with access-restricted target resources. Elements of system 100 can be configured to communicate using HTTP/HTTPs, SSH, RDP, or like protocols.

Source resource 101 can include one or more IoT devices, mobile devices, laptops, desktops, workstations, servers, clusters, or the like. In some embodiments, source resource 101 can be a virtual computing device, such as a virtual machine, container, pod, or service (e.g., a kubernetes service, or the like). Source resource 101 can be configured to provide requests to application programming interfaces (APIs) exposed by cloud environment 103, consistent with disclosed embodiments. Source application 101 can be configured to generate these API requests using a command line interface or software development kit associated with cloud environment 103. For example, when cloud environment 103 includes AMAZON WEB SERVICES, then source application 101 can be configured to generate API requests using open source AWS API CLI/SDK tools. The requests can include replica authentication information. In some embodiments, source application 101 can be configured with this replica authentication information. In various embodiments, source application 101 can be configured with source credentials for generating this replica authentication information. For example, source application 101 can be configured with cryptographic source keys for generating digital signatures of requests. In some aspects, the source credentials can be stored in local memory on the network resource hosting source application 101.

Cloud Environment 103 can include a cloud-computing platform, consistent with disclosed embodiments. Examples of suitable cloud-computing platforms include, but are not limited to, MICROSOFT AZURE, AMAZON WEB SERVICES, GOOGLE CLOUD PLATFORM, IBM CLOUD, and similar systems. Cloud environment 103 can be configured to host one or more access-restricted resources. Cloud computing environment 103 can be configured to expose APIs for interacting with the access-restricted resources. These APIs can enable applications to invoke, stop, and/or communicate data and/or information with the hosted services. Cloud environment 103 can be configured to refuse API requests targeted to these access-restricted resources unless the API requests can be authenticated or can be authenticated and authorized. As a non-limiting example, cloud environment 103 can be configured to host a payroll resource. Cloud computing 103 can expose an API enabling an application to use this payroll resource to create a payment to a recipient. Cloud environment 103 can be configured to refuse API requests targeted to this payroll resource unless signed using a cloud key of an authorized user.

Cloud environment 103 can be configured to validate requests received from proxy manager 107 using temporary authentication information included in the requests. In some embodiments, the temporary authentication information can comprise a cloud credential. Cloud environment 103 can be configured to validate the cloud credential (e.g., using an access control list, or the like). In various embodiments, the temporary authentication information can comprise a digital signature generated using a cloud credential. Cloud environment 103 can be configured to validate this digital signature using stored cloud credentials (e.g., a symmetric cloud key shared with proxy manager 107, or the like). In some embodiments, the temporary authentication information can comprise a digital signature generated using a signing credential derived from a cloud credential. Cloud environment 103 can be configured to validate this digital signature by recreating the signing credential from stored cloud credentials. For example, the digital signature can be generated from a cloud credential and certain identifying information, such as a timestamp and a geographic location. Cloud environment 103 can be configured to validate the digital signature by recreating the signing key using a stored cloud credential and the same identifying information. Cloud environment 103 can be configured to permit access-restricted resources to execute the API request when the request includes a valid access credential or digital signature.

For ease of description, the disclosed systems and methods are described herein with regard to a cloud-computing environment. However, as would be appreciated by one of skill in the art, the disclosed systems and methods are similarly applicable to an on-premises computing system. Such an on-premises computing system could include one or more physical or virtual machines hosting the access-restricted resources. In such embodiments, the disclosed functions and features of cloud environment 103 could be performed by the on-premises computing system.

Credential management resource 105 can include one or more desktops, workstations, servers, clusters, or the like. In some embodiments, credential management resource 105 can be a virtual computing device, such as a virtual machine, container, pod, or service (e.g., a kubernetes service, or the like). Credential management resource 105 can include a secure credential vault (e.g., an ENTERPRISE PASSWORD VAULT as provided by CYBERARK). Credential management resource 105 can be configured to include a web portal for communicating with the secure credential vault (e.g., a PASSWORD VAULT WEB ACCESS as provided by CYBERARK). The web portal can be configured to authenticate and/or authorize users requesting access to the secure credential vault. Authenticated and/or authorized users can interact with the web portal to review or provide parameters governing management of authentication and authorization information. For example, users can interact with the web portal to create, delete, or modify authorization policies, key rotation schedules, key evolution rules, and the like.

Credential management resource 105 can be configured to store credential information. The secure credential vault of credential management resource 105 can be configured to maintain one or more data structures associating source credentials with cloud credentials. In some aspects, the source credentials can include cryptographic source keys. In various aspects, the cloud credentials can include cryptographic cloud keys. In some embodiments, the secure credential vault can be configured to store key pairs. Each key pair can include a source key and a cloud key. In some embodiments, the inclusion of a source key can authenticate a request received from source resource 101. In various embodiments, the inclusion of replica authentication information generated by a source key can authenticate a request received from source resource 101. In some embodiments, the inclusion of a cloud key can authenticate a request provided to cloud environment 103. In various embodiments, the inclusion of temporary authentication information generated by a source key can authenticate a request provided to cloud environment 103. In some aspects, the cryptographic keys can be symmetric keys.

Credential management resource 105 can be configured to provide credentials to proxy manager 107. These credentials can be provided in response to a request from proxy manager 107. In some aspects, the request from proxy manager 107 can include credential identification information. Credential management resource 105 can be configured to use this credential identification information to retrieve the credentials from the secure credential vault. For example, credential management resource 105 can he configured to receive a request including a credential identification number (e.g., a source key ID). Credential management resource 105 can be configured to use this credential identification number retrieve stored credentials from a database (e.g., credential identification number can he an index field for the database). Credential management resource 105 can be configured to provide the credentials to proxy manager 107 in response to the request.

Credential management resource 105 can be configured to replace cloud credentials with new cloud credentials and/or replace source credentials with new source credentials. For example, credential management resource 105 can he configured to use a master cloud credential to generate new cloud credentials for including in, or using to generate, temporary authentication information. These new cloud credentials can then be stored in association with source credentials for including in, or using to generate, replica authentication. In some embodiments, credential management resource 105 can be configured to evolve a master cloud key, or a cloud key derived from the master cloud key, to generate a new cloud key. As an additional example, credential management resource 105 can be configured to use a master source credential to generate new source credentials for including in, or using to generate, replica authentication information.

Proxy manager 107 can include one or more desktops, workstations, servers, clusters, or the like. In some embodiments, proxy manager 107 can be a virtual computing device, such as a virtual machine, container, pod, or service (e.g., a kubernetes service, or the like). Proxy manager 107 can be configured to receive information from source resource 101. In some embodiments, proxy manager 107 can be configured to intercept requests from source resource 101. For example, proxy manager 107 can be configured as a proxy server that intercepts HTTP requests from source resource 101 to cloud environment 103.

Proxy manager 107 can be configured to receive source credentials and cloud credentials from credential management resource 105. In some embodiments, proxy manager 107 can be configured to request credentials from credential management resource 105. When the replica authentication information comprises a source credential, the credential request can include or indicate the replica authentication information. When the replica authentication information is generated by a source credential, the credential request can indicate the source credential. For example, the credential request can include a source credential ID (e.g., a source key ID).

Proxy manager 107 can be configured to authenticate requests received from source resource 101. When replica authentication information included in the request comprises a source credential, proxy manager 107 can be configured to authenticate the request using an access control list or like technique. When replica authentication information included in the request is generated using a source credential, proxy manager 107 can be configured to authenticate the request using a source credential retrieved from credential management resource 105. For example, when the replica authentication information includes a digital signature, proxy manager 107 can be configured to use a source key received from credential management resource 105 to validate the digital signature. In some aspects, proxy manager 107 can be configured to generate a digital signature over at least a portion of the request received from source 101 using the received source key (or a signing key derived from the received source key). Proxy manager 107 can compare the generated digital signature with the received digital signature to determine whether the request is authentic.

Proxy manager 107 can be configured to authenticate source resources providing requests. For example, proxy manager 107 can be configured to require sources to provide a certificate (such as a public key infrastructure (PKI) certificate) or token together with the request. In some embodiments, the certificate can be a certificate of the source resource. In various embodiments, the certificate or token can be provided to the source resource by an authentication service. In various aspects, a source resource can authenticate to proxy manager 107 using a web interface (e.g., using the CyberArk PVWA web interface). In some embodiments, proxy manager 107 can be configured to implement a multifactor authentication mechanism for authenticating source resource 101.

Proxy manager 107 can be configured to authorize requests received from source resource 101. Proxy manager 107 can be configured to authorize such requests according to policies governing API usage and credential usage. In some embodiments, proxy manager 107 can be configured to compare requests to profiles describing typical source activity. These profiles can be generated by applying statistical or machine learning techniques to received request traffic. Proxy manager 107 can be configured to reject a request unlike those typically received from a source and/or report an unusual request. For example, proxy manager 107 can be configured to log the unusual request or provide an alert describing the request to a user or other identity.

Proxy manager 107 can be configured to recreate requests received from source resource 101. In some embodiments, proxy manager 107 may only recreate authenticated requests or may only recreate authenticated and authorized requests. Recreating the request can include retrieving a cloud credential from credential management resource 105 in some aspects. Recreating the request can include creating temporary authentication information acceptable to cloud environment 103 in various aspects. Proxy manager 107 can be configured to include the cloud credential in the request as temporary authentication information, in some embodiments. Proxy manager 107 can be configured to use the cloud credential to generate temporary authentication information for inclusion in the request, in various embodiments. For example, when the temporary authentication information includes a digital signature, proxy manager 107 can be configured to create this digital signature using a cloud key retrieved from credential management resource 105 (or using a signing key generated from the retrieved cloud key). In sonic embodiments, recreating a request can include modifying an HTTP message received by proxy manager 107. For example, the proxy manager 107 can be configured to modify such an HTTP message by replacing the HTTP request query and/or the HTTP request header fields. In sonic aspects, the replacement HTTP request query and/or HTTP request header fields can include a digital signature generated using a cloud key received from credential management resource 105. For example, the temporary authentication information can be a keyed hash using the cloud key over at least a portion of the information in the HTTP message.

Proxy manager 107 can be configured to recreate responses received from cloud environment 103. Recreating the request can include retrieving a source credential from credential management resource 105, in some aspects. Recreating the request can include creating replica authentication information acceptable to source resource 101 in various aspects. Proxy manager 107 can be configured to include the source credential in the request as replica authentication information, in some embodiments. Proxy manager 107 can be configured to use the source credential to generate replica authentication information for inclusion in the request, in various embodiments. When such replica authentication information includes a digital signature, proxy manager 107 can be configured to create this digital signature using a source key received from credential management resource 105 (or using a signing key generated from the received source key). In some embodiments, recreating a request can include modifying an HTTP message received by proxy manager 107. For example, the proxy manager 107 can be configured to modify the HTTP message by replacing the HTTP query and/or the HTTP header fields. In some aspects, the replacement HTTP query and/or HTTP header fields can include a digital signature generated using a credential received from credential management resource 105. In some embodiments, the credential can be a source key and the digital signature can depend on one or more of a source key identifier and a source key value.

FIG. 1B depicts logical components of credential management resource 105, consistent with disclosed embodiments. In some embodiments, credential management resource 105 can be configured to maintain credential database 111. Though depicted in FIG. 1B as a table, the particular data structure used by credential database 111 to store the associations is not intended to be limiting.

Credential database 111 can be configured to store cloud credentials and source credentials, consistent with disclosed embodiments. Cloud credentials can constitute temporary authentication information, in some aspects, or be useable to generate temporary authentication information, in various aspects. For example, the cloud credentials can be cryptographic keys. The source credentials can constitute replica authentication information, in some aspects, or be useable to generate replica authentication information, in various aspects. For example, the source credentials can be cryptographic keys. As shown in FIG. 1B, in some embodiments credential database 111 can be configured to store N cloud keys and N source keys. In some embodiments, credential database 111 can be configured to store specific cloud keys corresponding to specific restricted-access resources hosted on cloud environment 103. For example, cloud environment 103 can be configured to use a specific cloud key to authenticate requests for access to a specific corresponding restricted-access resource.

Credential database 111 can be configured to store differing numbers of unique cloud keys and source keys in some embodiments. For example, while credential database 111 can be configured to store N associations between cloud keys and source keys, credential database 111 could be configured to store fewer a N unique cloud keys and fewer than N unique source keys. As a non-limiting example, when credential database 111 stores 30 associations between cloud and source keys, credential database 111 can store associations between 30 unique source keys and one unique cloud key or associations between 5 unique cloud keys and 6 unique source keys.

Credential database 111 can be configured to store at least one source key for each unique cloud keys in various embodiments. For example, cloud environment 103 can host three restricted-access resources. Three cloud keys can uniquely correspond to the three restricted-access resources. A first source key can correspond to the first of the three cloud keys, two distinct source keys can correspond to the second of the three cloud keys, and two other distinct source keys can correspond to the third of the three cloud keys. In some aspects, there may be a one-to-one correspondence between cloud keys and source keys.

Credential management resource 105 can be configured to manage decoy replica authentication information credentials in some embodiments. System 100 can be configured to distribute such decoy credentials to one or more source resources. In some aspects, the decoy credentials can resemble actual temporary authentication information credentials in one or more of datatype, format, and value. But the decoy credentials may lack, in some aspects, a corresponding temporary authentication information credential. For example, the replica authentication information credentials can be cryptographic source keys lacking corresponding cloud keys. In some embodiments, such decoy credentials may not be represented in credential database 111 or may be represented by entries lacking corresponding temporary authentication information credentials. These decoy credentials can be, or be used to generate, decoy replica authentication information that cannot be used to access the access-restricted resources, at least because this decoy replica authentication information does not correspond to any temporary authentication that could be used to access the access-restricted resources hosted on cloud environment 103.

Credential management resource 105 can be configured to generate source keys according to key generation rules 113. Key generation rules 113 can specify, in some embodiments, that credential management resource 105 generate source key values randomly. Key generation rules 113 can specify, in various embodiments, that credential management resource 105 generate source key values including metadata information. For example, the source key values can include metadata identifying a source resource, a target API, source IP address, a governing authorization policy, or the like. In some aspects, proxy manager 107 can be configured to use such metadata when authorizing a request from source resource 101. In some embodiments, as shown in FIG. 1B, the source keys can include multiple parts. Though the source keys are all shown with M parts, source keys can differ in the number of parts they include, and the depicted format is not intended to be limiting. As a non-limiting example:

Source Key: wJalrXUtnFEMI/K7MDENG/appXR/50.23/432

In this non-limiting example, the tokens “appXR,” “50.23,” and “432” convey information about the source resource, a source IP address, and a governing authorization policy. In some embodiments, source resource 101 can be configured to encrypt one or more of these tokens prior to sending a request to cloud environment 103. Proxy manager 107 can be configured to intercept this request and decrypt any encrypted tokens during authentication or authentication and authorization of the request. Proxy manager 107 can be provisioned with a suitable key for decrypting any encrypted tokens by another component of system 100 (e.g., source resource 101, cloud environment 103, or credential management resource 105).

Key generation rules 113 can specify, in some embodiments, that a source key be useable for a limited number of uses. For example, key generation rules 113 can specify that credential management resource 105 generate a source key corresponding to source resource 101 after every request by source resource 101. For example, source resource 101 and credential management resource 105 can be provisioned with a master source key:

Master source key: wJalrXUtnFEMI/K7MDENG/bPxRfiCYIu7Gyis00

Source resource 101 and credential management resource 105 can be provisioned with a “key generation rule”. For example, a simple key generation rule could require the value of a portion of the source key be incremented with each request generated by source resource 101. Accordingly to this simple key generation rule, the source key used to generate the replica authentication information for the first source resource 101 request could be:

Request 1: wJalrXUtnFEMI/K7MDENG/bPxRfiCYIu7Gyis01

The source key used to generate the replica authentication information for the second source resource 101 request could then be:

Request 2: wJalrXUtnFEMI/K7MDENG/bPxRfiCYIu7Gyis02

As would be appreciated by one of skill in the art, the simple key generation rule provided in this example is not intended to be limiting. Credential manager 105 can be configured, in some embodiments, to provide the current key value to proxy manager 107 in response to a credential request. Proxy manager 107 can then use this current key value when attempting to authenticate a request from a source resource. In this manner, credential management resource 105 can be configured to automatically enforce one-time usage of each derived source key. An attacker would be unable to attempt a replay attack using a previously sent request, as the source key would no longer be valid.

In some embodiments, a master source key can specify a remaining number of uses. Source resource requests can decrement this remaining number of uses. For example, the master source key could end in “ . . . 02”. A key included in or used to generate replica authentication information for a second source resource request could then end in “ . . . 00”. Proxy manager 107 can be configured, in some aspects, to reject additional API requests once zero uses of the master source key remained. For example, credential manager 105 could be configured to stop generating additional keys once the remaining number of uses reached “00.” In such embodiments, credential manager 105 can then indicate that no corresponding key exists in response to credential requests from proxy manager 107.

FIG. 1C depicts logical components of proxy manager 107, consistent with disclosed embodiments. Proxy manager 107 can be configured to store, in some embodiments, API rules 115 and source profiles 117. Proxy manager 107 can be configured to apply authorization policies based on API rules 115 and/or source profiles 117. Proxy manager 107 can be configured to apply these authorization policies to intercepted requests from source resource 101. Proxy manager 107 can be configured to deny access to an access-restricted target resource hosted by cloud environment 103 when the intercepted request does not comply with the applied authorization policy. For example, proxy manager 107 may not recreate the request with temporary authentication information and forward such a recreated request to cloud environment 103 when the request does not comply with the applied authorization policy. In some embodiments, proxy manager 107 can be configured to take remedial action when a request does not comply with an applied authorization policy. For example, proxy manager 107 can be configured to block further requests from the requesting source resource, block further requests using that source key, and/or provide or log an indication of the compliance failure.

Proxy manager 107 can be configured to apply the authorization policy using metadata in a source key. Considering the source key:

Source Key: wJalrXUtnFEMI/K7MDENG/appXR/50.23/432

As described above, this exemplary source key can include tokens “appXR,” “50.23,” and “432,” which can convey information about the source resource, an IP address of the request, and an authorization policy governing the request.

API Rules 115 can include rules specifying which source resources can use which source keys. For example, API rules 115 can include a rule restricting the use of keys including the token “appXR” to the source resource indicated by the identifier “appXR”. In this example, proxy manager 107 can be configured not to forward API requests originating from another source resource and including, or signed using, this source key. In some aspects, proxy manager 107 can be configured to provide an indication, such as an alert, when it intercepts a request including, or signed using, a source key comprising the token “appXR” from another source resource.

API Rules 115 can include rules specifying when and/or how many times source keys can be used. For example, API rules 115 can include a rule imposing a time limit on source key validity. Such a rule can specify that a source key is only valid for 30 minutes from creation of the source key. A source key can be configured to include a token specifying when the source key was created. In this example, proxy manager 107 can be configured to apply this rule to intercepted requests from source resource 101. Proxy manager 107 can be configured to deem the source key expired when the token indicates that the source key was created more than 30 minutes earlier. Proxy manager 107 can be configured not to forward API requests including or signed by this expired source key. In this manner, API Rules 115 can impose a time limit on source cryptographic key validity. In some aspects, proxy manager 107 can be configured to provide an indication, such as an alert, when it intercepts a request including or signed by an expired source key.

API rules 115 can include rules imposing usage limits on source cryptographic key validity. Such a rule can specify that a source key remains valid for a single use or for a predetermined number of uses. The source key can include a token specifying the number of times the source key has been used in some aspects. For example, when a source key is created according to key evolution rule, the source key can be configured to include a token specifying the number of evolutions the key has undergone. Proxy manager 107 can be configured to track the number of times that the source has been used in various aspects. In this example, proxy manager 107 can be configured to apply a rule imposing usage limits to requests intercepted from source resource 101. When the token indicates that the source key has been used too many times, proxy manager 107 can be configured to deem the source key invalid. Proxy manager 107 can be configured not to forward API requests signed by invalid source keys. In this manner, API rules 115 can be configured to impose a single-usage limit on source cryptographic key validity. In some aspects, proxy manager 107 can be configured to provide an indication, such as an alert, when it intercepts a request including an invalid source key.

API Rules 115 can include rules concerning IP addresses. In some aspects, API Rules 115 can include one or more 111? address whitelist rules and one or more IP address blacklist rules. For example, according an IP address whitelist rule, proxy manager 107 may only forward API requests received from certain IP addresses. As an additional example, when the IP address 192.128.50.23 is on such as whitelist, proxy manager 107 may be permitted to forward a request including, or signed by, a source key including the token “50.23” (which can indicate in this example that the source request was created by a source resource with the IP address 192.128.50.23). In some aspects, proxy manager 107 can be configured to provide an indication, such as an alert, when it intercepts a request from another IP address including, or signed by, a source key including the token “50.23”.

Source profiles 117 can include information describing typical source resource requests. In some embodiments, source profiles 117 can include statistical information describing the likelihood of a request, or a sequence of requests, by a source resource. Proxy manager 107 can be configured to use this statistical information to create source usage profiles for source keys. Proxy manager 107 can be configured to identify the source key included in, or used to generate, the replica authentication information and evaluate a likelihood of the request based on the stored usage profile. When the likelihood fails to meet a likelihood criterion, proxy manager 107 can be configured not to forward such requests and/or configured to provide an indication of such a failure, such as an alert. In various embodiments, source profiles 117 can include machine-learning based classifiers, such as neural networks. These machine-learning based classifiers can be trained using features extracted from a record of prior requests. In some embodiments, proxy manager 107 can be configured to generate this record from intercepted requests. Proxy manager 107 can be configured to apply one or more machine-learning based classifiers to intercepted requests to classify them as benign or anomalous. Proxy manager 107 can be configured not to forward anomalous requests and/or configured to provide an indication of anomalous requests, such as an alert. In some embodiments, proxy manager 107 can be configured to recommend an authorization policy for a source resource based on similarities with other source resources, similarities to a template, or predetermined rules (e.g., source resources that provide requests to create access keys shall be governed by an “administrator policy”)

Proxy manager 107 can be configured to create authorization policies including one or more rules selected from API rules 115 and/or one or more profiles selected from source profiles 117. In some embodiments, authorization policies can be attached to source keys and/or source resources. For example, an authorization policy for a source key including the token “appXR” can specify that API calls including, or generated using, this source key must be performed in the time window of 8:00 AM till 20:00 PM, from the IP address 192.128.50.23, from machine name of “serverXR”, and may call API “read” and “update” actions, but not API “delete” actions. Proxy manager 107 can be configured to block other requests including, or using, this source key. As an additional example, an authorization policy for source resource 101 can specify that API calls from this source resource may only call API “read” actions, but not restrict the time window or IP address. Proxy manager 107 can be configured to block other requests from source resource 101. In some embodiments, proxy manager 107 can be configured to store authorization polices. These stored policies can be associated with identifiers (e.g., the identifier “432”). In some embodiments, a source key can specify a particular governing policy. Considering the exemplary key provided above, the token “432” can indicate that authorization policy “432” governs the use of that key.

Proxy manager 107 can be configured to combine stored authorization policies with other authorization policies or rules (e.g., ones of API rules 115 and/or source profiles 117) to create new policies. For example, proxy manager 107 can be configured to store a set of rules as policy “432”. Proxy manager 107 can be configured to create a new policy “433” as the logical AND of policy “433” and an additional rule. In some aspects, proxy manager 107 can be configured to store this new policy. In various aspects, proxy manager 107 can be configured to apply this new policy “433” to requests intercepted from a source resource (e.g., source resource 101).

In some embodiments, proxy manager 107 can be configured to use authorization policies to govern generation of temporary authentication information. For example, proxy manager 107 can be configured to specify time intervals for replacing cloud credentials included in, or used to generate, temporary authentication information. For example, during each time interval proxy manager 107 can be configured to request a new cloud credential from credential management resource 105 or cloud environment 103. As an additional example, during each time interval proxy manager 107 can be configured to evolve an existing cloud credential to generate a new cloud credential for use during the specified time interval.

Proxy manager 107 can be configured to use authorization policies to detect anomalous usage of a source credential. In some embodiments, based on a single authorization policy violation or a history of authorization policy violations, credential management resource 105 or proxy manager 107 can be configured to determine whether a source resource (e.g., source resource 101) or source credential appears compromised. For example, proxy manager 107 can be configured with rules for identifying compromised source resources or source credentials. These rules can depend on at least one of the number of violations, the recency of violations, or the type or magnitude of violations.

Proxy manager 107 can be configured to respond to an authorization policy violation. In some embodiments, when proxy manager 107 identifies a source credential as compromised, proxy manager 107 can be configured to cease forwarding requests including, or signed with, this source credential. In various embodiments, when proxy manager 107 identifies a source resource as compromised, proxy manager 107 can be configured to cease forwarding requests from this source resource. In some embodiments, proxy manager 107 can be configured to provide an indication, such as an alert. This indication can be provided to a user or administrator account. In some aspects, the indication can flag the source resource or source credential for investigation. In various aspects, proxy manager 107 can be configured to provide the indication for display on a user console. Additionally or alternatively, proxy manager 107 can be configured to log the authorization policy violation and/or the identification of the source resource or source key as compromised.

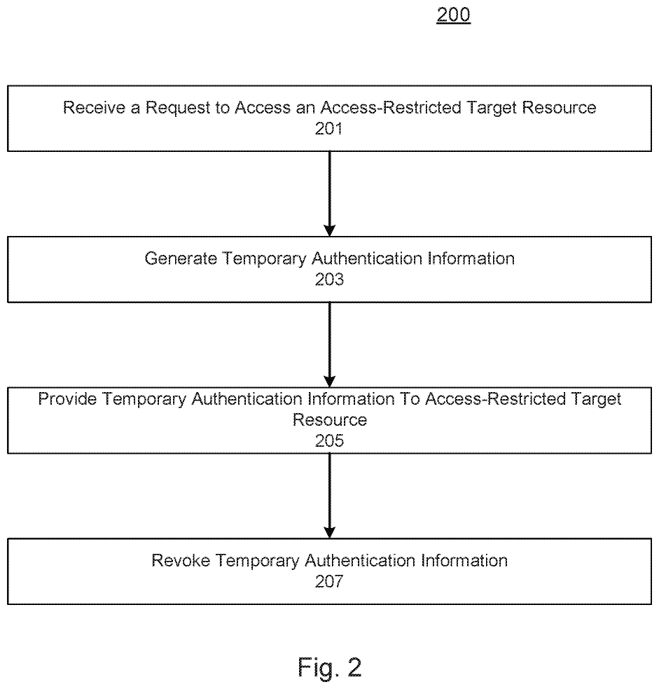

FIG. 2 depicts an exemplary method 200 for enabling source resources to communicate with access-restricted target resources, consistent with disclosed embodiments. Method 200 can include the steps of receiving a request to access an access-restricted target resource, generating temporary authentication information, providing the temporary authentication information to the access restricted target resource, and revoking the temporary authentication information.

After starting, method 200 can proceed to step 201. In step 201, proxy manager 107 can receive a request to access an access-restricted target resource in step 201. In some aspects, the request can be an API request from an application running on source resource 101. For example, an application running on source resource 101 can be configured to request information stored in a database accessible to an access-restricted resource on cloud-environment 103. As previously described, in some embodiments system 100 can be configured to route communications between source resource 101 and cloud environment 103 through proxy manager 107. Proxy manager 107 can be configured to filter these communications, intercepting requests satisfying one or more criteria. For example, proxy manager 107 can be configured to intercept API requests from an application running on the source resource. These API request can be directed to one or more access-restricted target resources hosted by cloud environment 103.

The request provided to cloud environment 103 can include replica authentication information. This replica authentication information can be inoperable to enable the source resource to access the access-restricted target resource hosted by cloud environment 103. For example, as described above, this replica authentication information can include, or be generated using, a source credential, such as a cryptographic source key. In some aspects, cloud environment 103 may lack this source key, or may be configured to validate requests using a differing cloud key. Therefore, in such embodiments, cloud environment 103 can be unable to authenticate the request from source resource 101.

After step 201, method 200 can proceed to step 203. In step 203, proxy manager 107 can generate temporary authentication information. This temporary authentication information can be generated, in some embodiments, in response to the request received (e.g., intercepted) from source resource 101. The temporary authentication information can correspond to the replica authentication information. For example, the cloud credential included in, or used to generate, the temporary authentication information can be associated with the source credential included in, or used to generate, the replica authentication information.

Proxy manager 107 can be configured to dynamically create a credential for inclusion in, or generation of, the temporary authentication information in some embodiments. For example, proxy manager 107 can be configured to request a new credential from cloud environment 103. In some embodiments, the new credential can be a temporary credential (e.g., a temporary security credential generated using AWS SECURITY TOKEN SERVICE). As an additional example, proxy manager 107 can be configured to evolve an existing key to generate a new cloud key.

Proxy manager 107 can be configured to request credentials for inclusion in, or for generating, temporary authentication information from credential management resource 105. This request can include information received by proxy manager 107 from source resource 101. For example, proxy manager 107 can be configured to provide information identifying the source credential included in, or used to generate, the replica authentication information. For example, when the replica authentication information is a digital signature generated using a source key, proxy manager 107 can be configured to provide information identifying the source key. In some embodiments, proxy manager 107 can be configured to receive source credentials from credential manager resource 105.

Proxy manager 107 can be configured to include credentials received from credential management resource 105 in temporary authentication information corresponding to the replica authentication information, or use credentials received from credential management resource 105 to generate temporary authentication information corresponding to the replica authentication information. For example, proxy manager 107 can be configured to receive a cloud key. This cloud key can correspond to the source key according to an association maintained by credential management resource 105. Proxy manager 107 can be configured to include the cloud key in the temporary authentication information or generate temporary authentication information using cloud key and the request received in step 201. For example, the cloud key can be used to sign a recreated request (or a signing string corresponding to the recreated request).

After step 203, method 200 can proceed to step 205. In step 205, proxy manager 107 can make the temporary authentication information available to access-restricted target resource 205. As described above, cloud environment 103 can be configured to host access-restricted target resources and in some aspects proxy manager 107 can be configured to provide the temporary authentication information to cloud environment 103. In some embodiments, the cloud environment 103 can be provisioned with the cloud key. This provisioning can occur before, during, or after creation of the temporary authentication information. Cloud environment 103 can be configured to use the cloud key to authenticate requests received from proxy manager 107. For example, in some embodiments, cloud environment 103 can be configured to match the provisioned cloud key to the cloud key included in the temporary authentication information. As an additional example, in various embodiments, cloud environment 103 can be configured to construct a digital signature using information contained in the request from proxy manager 107 (e.g., credential scope, request method, query string, and the like). Cloud environment 103 can then compare the constructed digital signature with the digital signature in the recreated request, permitting access to the access-restricted target resource when the digital signatures match. In some embodiments, proxy manager 107 can be configured to include in the recreated request the temporary authentication information and additional authentication information. For example, proxy manager 107 can be configured to provide an authentication token together with the digital signature. In some embodiments, the authentication token can be used to authenticate the proxy manager 107.

Proxy manager 107 can be configured to provide a recreated request including the temporary authentication information to cloud environment 103. In some embodiments, proxy manager 107 can be configured to generate a new message including the temporary authentication information and send the new message to the access-restricted target resource. In various aspects, proxy manager 107 can be configured to modify the original request received from source resource 101 to include the temporary authentication information (which in some aspects can include, or by generated using, a cloud credential). For example, proxy manager 107 can be configured to replace the portion of the request with the temporary authentication information. For example, when the request received from proxy manager 107 is an HTTP message, proxy manager 107 can be configured to modify at least one of a query string or an authentication header of the HTTP message to include the temporary authentication information.

After receiving a request from source resource 101, proxy manager 107 can be configured to generate the temporary authentication information and make it available to cloud environment 103, without further involving source resource 101. Proxy manager 107 can, in some aspects, be configured to send the temporary authentication information directly to cloud environment 103, without sending the temporary authentication information to source resource 101.

After step 205, method 200 can be configured to proceed to step 207. In step 207, proxy manager 107 can be configured to revoke the temporary authentication information. Proxy manager 107 can be configured to perform this revocation after making temporary authentication information available to the access-restricted target resource. For example, proxy manager 107 can be configured to perform this revocation upon the termination of a session between the source resource and the access-restricted target resource. In some aspects, the revocation can include revoking the cloud credential included in, or used to generate, the temporary authentication information.

Proxy manager 107 can be configured to perform this revocation according to a revocation schedule. For example, proxy manager 107 can be configured to obtain a new cloud credential for including in, or for generating, the temporary authentication information and revoke the prior credential each hour, day, week, month, or year. Proxy manager 107 can be configured to perform this revocation based on the elapsed time since creation of the credential for inclusion in, or for generating, the temporary authentication information. Proxy manager 107 can be configured to perform this revocation based on a number of uses of the credential, or a number of requests including or using the credential.

Proxy manager 107 can be configured to perform the revocation by evolving the cloud credential included in, or used to generate, the temporary authentication information, so that new attempts to include or generate the temporary authentication information will use a different cloud credential. Proxy manager 107 can be configured to perform the revocation by storing a revocation indication. This revocation indication can indicate that the temporary authentication information and/or the cloud credential included in, or used to generate, the temporary authentication information has been revoked. For example, cloud environment 103 can be configured to store an indication of the creation time of the cloud credential used to generate the temporary authentication information. After a certain amount of time has elapsed, as measured using the stored indication, proxy manager 107 can be configured to stop generating temporary authentication information using the cloud credential. As and additional example, cloud environment 103 can be configured to store an indication that the cloud credential has been previously used. Proxy manager 107 can be configured not to generate temporary authentication information with previously used cloud credentials. In some embodiments, proxy manager 107 can be configured to remove the cloud credential from credential database 111.

Additionally or alternatively, in step 207, proxy manager 107 can be configured to revoke the replica authentication information. Proxy manager 107 can be configured to perform this revocation after receiving the replica authentication information, or according to a revocation schedule. Proxy manager 107 can be configured to perform this revocation based on the elapsed time since creation of the source credential included in, or used to generate, the replica authentication information. Proxy manager 107 can be configured to perform this revocation based on a number of uses of the credential to generate the replica authentication information, or a number of uses of the replica authentication information. Proxy manager 107 can be configured to perform this revocation by evolving the source credential included in, or used to generate, the replica authentication information (e.g., the source key), so that the source credential can no longer be used to authenticate the replica authentication information. Proxy manager 107 can be configured to perform this revocation by storing a revocation indication, as described above. In this manner, proxy manager 107 can be configured to ensure, for example, the automated self-changing of the source credentials by enforcing one-time usage of source credentials by source resource 101.

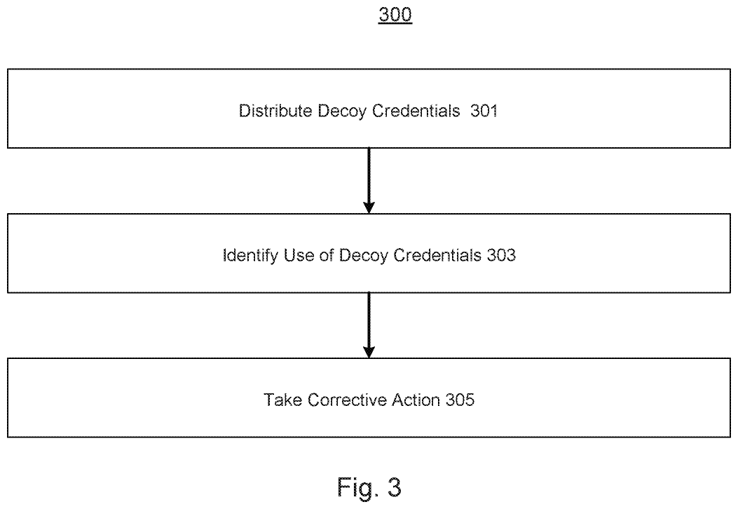

FIG. 3 depicts an exemplary method 300 for detecting compromised systems. Method 300 can include distributing decoy credentials, identifying use of the decoy credentials, and taking corrective action. In some aspects, method 300 can enable detection of attackers seeking to exploit credentials accessible to the source resources. Because the credentials cannot be used to access cloud environment 103, distributing them throughout system 100 may not compromise the security of cloud environment 103. But attackers may be unable to distinguish between decoy credentials and actual credentials. Accordingly, attackers may provide requests including, or generated using, decoy credentials. Proxy manager 107 can be configured to monitor system 100 for such requests, which can indicate that a source resource has been compromised.

After starting, method 300 can progress to step 301. In step 301, proxy manager 107 (or another component of system 100, such as credential management resource 105) can distribute decoy credentials. The decoy credentials can resemble actual source credentials used by system 100 in datatype, format, value, or the like. However, proxy manager 107 and/or credential management resource 105 can be configured such that requests with replica authentication information including, or generated using, the decoy credentials are not forwarded to cloud environment 103.

The decoy credentials can be distributed to the source resources (and optionally other computing devices associated with an organization responsible for the source resources). For example, when the source resources operate on a computing infrastructure of an organization, the decoy credentials can he distributed throughout this computing infrastructure. In some embodiments, the decoy credentials can be stored in the local memories of the source resources (and optionally in the local memories of other computing devices in the computing infrastructure). In some aspects, the decoy credentials can be stored using same security precautions as actual source credentials. In various aspects, the decoy credentials can be stored using minimal security precautions. For example, the decoy credentials can be stored as plaintext and optionally identified as access credentials. As an additional example, the decoy credentials can be stored in an unencrypted code repository (e.g., a GitHub repository) or posted to a social media platform (e.g., a Slack Channel).

After step 301, method 300 can progress to step 303. In step 303, proxy manager 107 can be configured to identify use of decoy credentials. As previously described, proxy manager 107 can be configured to intercept requests from source machines to cloud environment 103. Proxy manager 107 can therefore intercept requests including, or generated using, decoy credentials. In some embodiments, system 100 can be configured to operate under the assumption that legitimate users would not provide such requests, as in such embodiments requests including, or generated using, the decoy credentials are not forwarded to cloud environment 103. Proxy manager 107 can therefore be configured to monitor the use of these decoy credentials. In some aspects, proxy manager 107 can be configured to identify as potentially compromised source resources that provide requests including, or generated using, decoy credentials.

After step 303, method 300 can progress to step 305. In step 305, proxy manager 107 can be configured to take corrective action in response to identifying the use of decoy credentials. In some embodiments, proxy manager 107 can be configured to provide an indication, such as an alert, upon detecting a request including, or generated using, decoy credentials. The report can be provided a user or administrator account. In some aspects, the indication can flag the source resource for investigation. Such an investigation can include determining whether the origin of a request was spoofed (e.g., the request did not originate with the source resource that appeared to provide the request). In various aspects, proxy manager 107 can be configured to provide the indication for display on a user console. Additionally or alternatively, proxy manager 107 can be configured to log the request. Proxy manager 107 can be configured to cease forwarding requests from a potentially compromised source resource, in some embodiments, regardless of the source credential included in, used to generate, the request. In some embodiments, proxy manager 107 can be configured to provide instructions to another component of system 100 (e.g., cloud environment 103 or credential management resource 105). These instructions can direct the other component to evolve, rotate, or otherwise change the cloud credentials used by system 100. This can address the possibility that the attacker may have already obtained access to cloud credentials used by system 100.

### EXAMPLES

The following non-limiting examples illustrate performance of certain embodiments of the disclosed systems and methods.

According to a first example, an employee copies API access keys of an application that he is developing. He latter attempts to use the copied API access keys to submit unauthorized API requests to cloud environment 103. However, because the application was developed for use with proxy manager 107, requests including, or generated using, the stolen API keys cannot be submitted directly to cloud environment 103. Requests submitted to proxy manager 107 can also be denied, as these requests may not satisfy authorization policies imposed by proxy manager 107. For example, the API keys can include metadata specifying a particular source resource or IP address, which may not match the source resource or IP address used by the employee. The employee never accesses the cloud credentials, which are stored on one or more of the proxy manager 107 and the credential management resource 105.

According to a second example, an employee accidentally publishes API keys to a public code repository (e.g., a public GitHub repository). As in the prior example, requests including, generated using, the published API keys cannot be submitted directly to cloud environment 103. Proxy manager 107 can also be configured to identify unauthorized requests generated using the published keys (e.g., proxy manager 107 can be configured to maintain an IP address whitelist).

As apparent from the above examples, the benefits of the disclosed systems and methods include the enforcement of proxy manager 107 as a single credential management point. This allows proxy manager 107 to be used for coordinating rotation of credentials, logging and auditing credential requests, searching for anomalous credential usage, and similar activities.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium containing instructions that, when executed by at least one processor, cause the at least one processor to perform operations for enabling source resources to communicate with access-restricted target resources, the operations comprising:
receiving, at a proxy manager, a request from a source resource to access an access-restricted target resource, the request including authentication information that is inoperable to enable the source resource to access the access-restricted target resource;
generating, in response to the request, temporary authentication information corresponding to the replica authentication information, the temporary authentication information being operable to enable the source resource to access the access-restricted target resource;
making available to the access-restricted target resource the temporary authentication information, without sending the temporary authentication information to the source resource; and
revoking the temporary authentication information after it was made available to the access-restricted target resource.

2. The non-transitory computer readable medium of claim 1, wherein making available to the access-restricted target resource the temporary authentication information includes modifying the request to include the temporary authentication information.

3. The non-transitory computer readable medium of claim 2, wherein modifying the request includes signing at least a portion of the request using a cryptographic cloud key to generate the temporary authentication information.

4. The non-transitory computer readable medium of claim 1, wherein making available to the access-restricted target resource the temporary authentication information includes generating, at the proxy manager, a new message including the temporary authentication information and sending the new message to the access-restricted target resource.

5. The non-transitory computer readable medium of claim 1, wherein making available to the access-restricted target resource the temporary authentication information includes combining the temporary authentication information with additional authentication information.

6. The non-transitory computer readable medium of claim 1, wherein the revoking occurs upon the termination of a session between the source resource and the access-restricted target resource.

7. The non-transitory computer readable medium of claim 1, wherein the revoking occurs according to a revocation schedule.

8. The non-transitory computer readable medium of claim 1, wherein the operations further comprise:
identifying a portion of the request comprising the replica authentication information; and
modifying the request by replacing the portion of the request with a substitute portion comprising the temporary authentication information.

9. The non-transitory computer readable medium of claim 1, wherein the replica authentication information is generated using a corresponding cryptographic source key and the temporary authentication information is generated using a corresponding cryptographic cloud key.

10. The non-transitory computer readable medium of claim 1, wherein the request is an API request from an application running on the source resource.

11. The non-transitory computer readable medium of claim 10, wherein a cryptographic source key for inclusion in, or for use in generating, the replica authentication information is integrated into the application.

12. The non-transitory computer readable medium of claim 1, wherein a cryptographic source key for generating the replica authentication information is stored in local memory on the source resource.

13. The non-transitory computer readable medium of claim 1, wherein the proxy manager is configured to intercept the request before it reaches the access-restricted target resource.

14. The non-transitory computer readable medium of claim 1, wherein a credential management resource is configured to store pairs of corresponding cryptographic source keys for including in, or for generating, replica authentication information and cryptographic cloud keys for including in, or for generating, temporary authentication information.

15. The non-transitory computer readable medium of claim 14, wherein the proxy manager is configured to replace the cloud credentials with replacement cloud credentials.

16. The non-transitory computer readable medium of claim 1, wherein the replica authentication information includes metadata identifying the source resource.

17. A computer-implemented method for enabling source resources to communicate with access-restricted target resources, the method comprising:
receiving, at a proxy manager, a request from a source resource to access an access-restricted target resource, the request including replica authentication information that is inoperable to enable the source resource to access the access-restricted target resource;
generating, in response to the request, temporary authentication information corresponding to the replica authentication information, the temporary authentication information being operable to enable the source resource to access the access-restricted target resource;
making available to the access-restricted target resource the temporary authentication information, without sending the temporary authentication information to the source resource; and
revoking the temporary authentication information after it was made available to the access-restricted target resource.

18. The computer-implemented method of claim 17, wherein the proxy manager applies an authorization policy to the request prior to making the temporary authentication information available to the access-restricted target resource.

19. The computer-implemented method of claim 18, wherein the proxy manager is configured to detect anomalous usage of a source cryptographic key.

20. The computer-implemented method of claim 18, wherein the proxy manager is configured to identify the source resource as compromised.

21. The computer-implemented method of claim 17, wherein the proxy manager is configured to detect use of replica authentication information including, or generated with, a decoy credential, the decoy credential created to identify potential malicious activity and lacking a corresponding credential for generating temporary authentication information.

22. The computer-implemented method of claim 18, wherein the authorization policy imposes a time limit on source cryptographic key validity.

23. The computer-implemented method of claim 18, wherein the authorization policy imposes a single-usage limit on source cryptographic key validity.

24. The computer-implemented method of claim 18, wherein the proxy manager is configured to deny access to the access-restricted target resource when the request does not comply with the authentication policy.

25. The computer-implemented method of claim 18, wherein the proxy manager is configured to flag the source resource for investigation when the request does not comply with the authentication policy.

26. The computer-implemented method of claim 18, wherein the proxy manager is configured to determine whether the replica authentication information is associated with the source resource.

27. The computer-implemented method of claim 17, wherein the proxy manager is configured to dynamically create a cloud credential for inclusion in, or for generating, the temporary authentication information in response to the request.
